(19) United States
(12) Patent Application Publication
(10) Pub. No.: US 2016/0242066 A1
(43) Pub. Date: Aug. 18, 2016

(54) METHOD AND SYSTEM FOR COMPENSATING FOR RETURN LINK RAIN ATTENUATION IN SATELLITE COMMUNICATION SYSTEM

(71) Applicant: Electronics and Telecommunications Research Institute, Daejeon (KR)

(72) Inventor: Joon Gyu RYU, Daejeon (KR)

(21) Appl. No.: 15/040,033

(22) Filed: Feb. 10, 2016

(30) Foreign Application Priority Data
Feb. 13, 2015 (KR) 10-2015-0022237

(51) Int. Cl. H04W 28/02; H04B 1/10; H04B 7/185

(52) U.S. Cl. CPC H04W 28/0236; H04B 7/18513; H04B 1/10

(57) ABSTRACT

A method for overcoming rain attenuation in a return link in a satellite communication system is provided. The method may include periodically receiving channel state information from a terminal, estimating a signal-to-noise ratio (SNR) based on the channel state information, determining, based on the estimated SNR, whether rain attenuation is to be compensated for, analyzing the channel state information and determining a rain attenuation compensation scheme, and transmitting an operating mode change command corresponding to the rain attenuation compensation scheme to the terminal.

### CROSS-REFERENCE TO RELATED APPLICATION

This application claims the benefit of Korean Patent Application No. 10-2015-0022237, filed on Feb. 13, 2015, in the Korean Intellectual Property Office, the disclosure of which is incorporated herein by reference.

### BACKGROUND

1. Field of the Invention

The following embodiments relate to a method for overcoming rain attenuation in a return link in a satellite communication system.

2. Description of the Related Art

Recently, due to a steady increase in a demand for emergency and disasters communication networks or broadband Internet services employing Internet protocol (IP)-based satellite communication network, a policy for universally providing satellite-based broadband communication services for the purpose of a solution of digital divide and construction of a high-speed Internet infrastructure is being promoted for satellite communication technologies in Britain or Japan.

For example, Inmarsat PLC is offering satellite communication services with respect to ships or manned and unmanned aircrafts using a satellite in a Kₐ band covering frequencies of 26.5 gigahertz (GHz) through 40 GHz, through a Global Xpress project. A demand for broadband Internet services based on the satellite in the Kₐ band for vehicles is expected.

However, because the Kₐ band is greater in a rain attenuation rate than at least two or three times a Kₐ, band of frequencies of 12 GHz through 18 GHz, a study on adaptive transmission technologies to overcome the above issue is required.

FIG. 1 is a graph illustrating a rain attenuation rate based on a frequency according to a related art.

Referring to FIG. 1, it is found that a rain attenuation rate in a Kₐ band is greater than at least two times a rain attenuation rate in a Kₐ band, as described above.

To overcome rain attenuation, a power control technology, an adaptive carrier selection (ACS) technology or an adaptive coding and modulation (ACM) technology are used. In a forward link for transmission from a central station to a terminal through a satellite, the power control technology and ACM technology have been developed and operated.

In a return link for transmission from the terminal to the central station through the satellite, the power control technology and ACS technology are generally being applied. Recently, research has been conducted on a VSAT technology employing the ACM technology.

In the ACM technology applied to the forward link, a transmission speed, for example, a symbol rate may be fixed, and a modulation and code rate (MODCOD) of performing transmission based on channel state information received from the terminal may be changed.

In the return link, a transmission power, a transmission speed, and a MODCOD may be changed. The transmission power may need to be changed based on a high power amplifier (HPA) capacity of a terminal by controlling an output of each terminal to prevent an interference with a neighboring carrier.

### SUMMARY

An aspect of the present invention is to provide a method and system for overcoming rain attenuation occurring in a return link based on a channel environment in a satellite communication system with great rain attenuation.

Specifically, the aspect is to enhance a throughput and availability of a system by changing a transmission speed and a transmission scheme in the satellite communication system.

According to an aspect, there is provided a method of compensating for return link rain attenuation in a satellite communication system, the method including periodically receiving channel state information from a terminal, estimating a signal-to-noise ratio (SNR) based on the channel state information, determining, based on the estimated SNR, whether rain attenuation is to be compensated for, analyzing the channel state information and determining a rain attenuation compensation scheme, and transmitting an operating mode change command corresponding to the rain attenuation compensation scheme to the terminal

The rain attenuation compensation scheme may include at least one of a transmission power change scheme, a transmission speed change scheme, and a modulation and code rate (MODCOD) change scheme.

The channel state information may include at least one of high power amplifier (HPA) margin information of the terminal and data information of the terminal.

The analyzing of the channel state information and determining of the rain attenuation compensation scheme may include analyzing the HPA margin information, and when an HPA margin of the terminal satisfies a predetermined criterion, determining the transmission power change scheme as the rain attenuation compensation scheme.

The analyzing of the channel state information and determining of the rain attenuation compensation scheme may include analyzing the HPA margin information, and when the HPA margin of the terminal does not satisfy the predetermined criterion, determining the MODCOD change scheme as the rain attenuation compensation scheme.

The analyzing of the channel state information and determining of the rain attenuation compensation scheme may include analyzing a MODCOD margin of the terminal, and when the MODCOD margin does not satisfy the predetermined criterion, determining the transmission speed change scheme as the rain attenuation compensation scheme.

According to another aspect, there is provided a system for compensating for return link rain attenuation to perform a method of compensating for return link rain attenuation, the system including a communicator configured to periodically receive channel state information from a terminal, and to transmit an operating mode change command corresponding to a rain attenuation compensation scheme to the terminal, an estimator configured to estimate an SNR based on the channel state information, and to determine, based on the estimated SNR, whether rain attenuation is to be compensated for, and a determiner configured to analyze the channel state information, and to determine a rain attenuation compensation scheme.

### EFFECT

According to embodiments, it is possible to overcome rain attenuation occurring in a return link based on a channel environment in a satellite communication system with great rain attenuation, by enhancing a throughput and availability of a system by changing a transmission speed and a transmission scheme.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a graph illustrating a rain attenuation rate based on a frequency according to a related art;

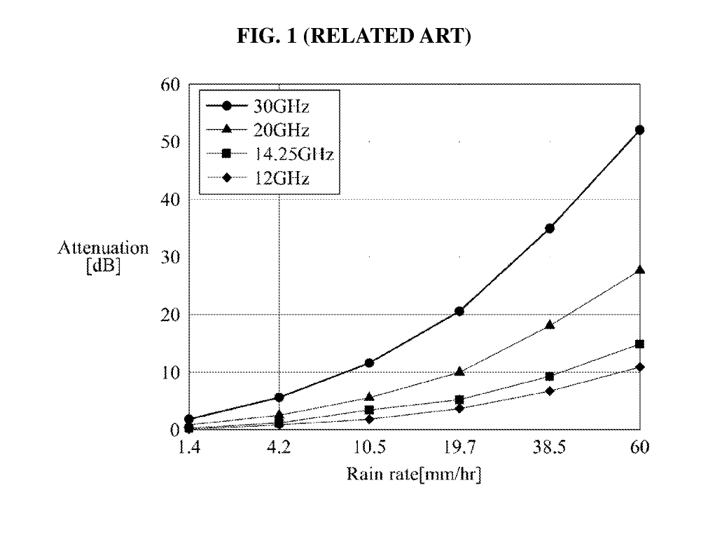

FIG. 2 is a diagram illustrating a configuration of a satellite communication system according to an embodiment;

FIG. 3 is a flowchart illustrating a method of compensating for return link rain attenuation in a satellite communication system according to an embodiment;

FIG. 4 is a diagram illustrating an order of a change in rain attenuation compensation schemes according to an embodiment;

FIG. 5 is a flowchart illustrating an example of a method of compensating for return link rain attenuation according to an embodiment; and

FIG. 6 is a block diagram illustrating a configuration of a return link rain attenuation compensation system to perform a return link rain attenuation compensation method according to an embodiment.

### DETAILED DESCRIPTION

Hereinafter, a method and system for compensating for return link rain attenuation in a satellite communication system will be further described with reference to the accompanying drawings.

Various alterations and modifications may be made to the embodiments. Here, the embodiments are not construed as limited to the disclosure and should be understood to include all changes, equivalents, and replacements within the idea and the technical scope of the disclosure.

The terminology used herein is for the purpose of describing particular embodiments only and is not to be limiting of the embodiments. As used herein, the singular forms “a”, “an”, and “the ” are intended to include the plural forms as well, unless the context clearly indicates otherwise. It will be further understood that the terms “include/comprise” and/or “have” when used in this specification, specify the presence of stated features, integers, steps, operations, elements, components, and/or combinations thereof, but do not preclude the presence or addition of one or more other features, numbers, steps, operations, elements, components, and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. When it is determined detailed description related to a related known function or configuration they may make the purpose of the embodiments unnecessarily ambiguous in describing the examples, the detailed description will be omitted here.

A transmission power change scheme, an adaptive carrier selection (ACS) technology or an adaptive coding and modulation (ACM) technology may be provided as a technology for overcoming rain attenuation. The present invention relates to a procedure used to apply three rain attenuation compensation technologies, and to a modulation and code rate (MODCOD) change procedure when the ACM technology is applied.

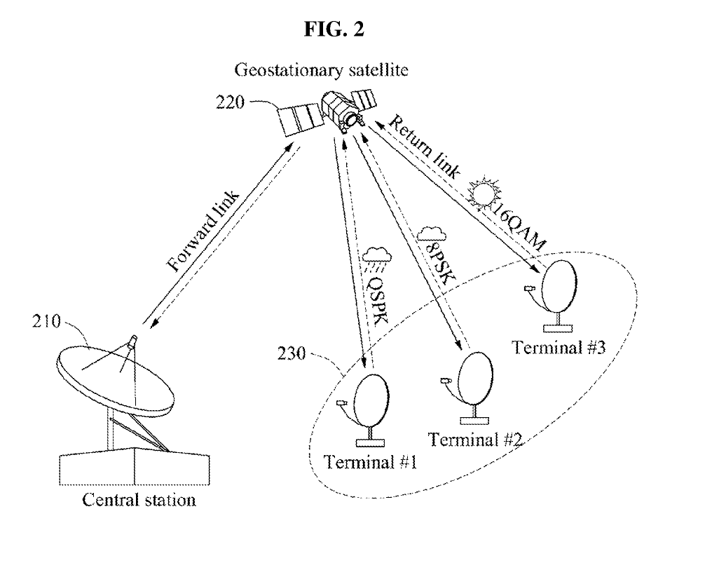

FIG. 2 is a diagram illustrating a configuration of a satellite communication system according to an embodiment.

The satellite communication system of FIG. 2 may include a central station 210, a geostationary satellite 220 and a terminal 230. Rain attenuation may occur in a return link for transmission from the terminal 230 to the central station 210 through the geostationary satellite 220.

Each of terminals #1 through #3 in the terminal 230 may periodically include channel state information in a synchronization maintenance signal, and may transmit the synchronization maintenance signal with the channel state information to the central station 210. The central station 210 may analyze the received synchronization maintenance signal, and may estimate signal-to-noise ratio (SNR) information of each of the terminals #1 through #3. The channel state information may include high power amplifier (HPA) margin information of a terminal and data information of the terminal

Whether an attenuation phenomenon occurs in a channel may be determined based on the SNR information, and whether rain attenuation is to be compensated for may be determined based on a predetermined criterion. For example, when a rain attenuation rate is greater than a predetermined criterion, rain attenuation compensation may be applied to a corresponding terminal.

The central station 210 may determine a rain attenuation compensation scheme suitable for a channel environment of each terminal 230, and may transmit a signal including an operating mode change command to apply the rain attenuation compensation scheme to each terminal 230.

The rain attenuation compensation scheme may correspond to, for example, at least one of the above-described transmission power change scheme, a transmission speed change scheme and a MODCOD change scheme to which an ACS technology and an ACM technology are applied.

To transmit a signal, the central station 210 and the terminal 230 may communicate through the geostationary satellite 220.

The terminal 230 may transmit a signal by applying the rain attenuation compensation scheme included in the received operating mode change command

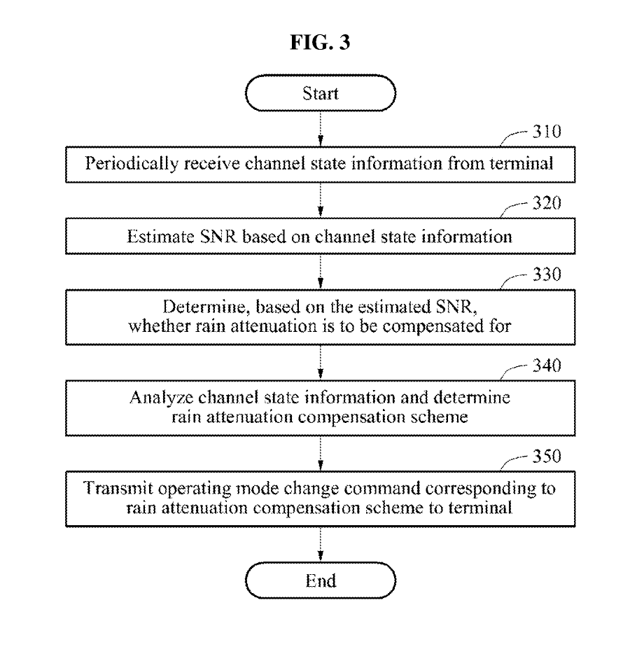

FIG. 3 is a flowchart illustrating a method of compensating for return link rain attenuation in a satellite communication system according to an embodiment. The method of FIG. 3 may be performed by a return link rain attenuation compensation system included in the satellite communication system of FIG. 2.

Referring to FIG. 3, in operation 310, channel state information may be periodically received from a terminal.

For example, channel state information may be received from each of all terminals connected via a satellite communication. The received channel state information may include at least one of HPA margin information of a terminal and data information of a terminal.

In operation 320, an SNR may be estimated based on the channel state information.

In operation 330, whether rain attenuation is to be compensated for may be determined based on the estimated SNR.

For example, whether rain attenuation or fading occurs in a channel may be determined based on the estimated SNR. When a value of the estimated SNR is equal to or less than a predetermined reference value, the rain attenuation may be determined to occur. When the rain attenuation is determined to occur, the rain attenuation may be determined to be compensated for.

In operation 340, the received channel state information may be analyzed and a rain attenuation compensation scheme may be determined

For example, at least one of the above-described transmission power change scheme, a transmission speed change scheme and a MODCOD change scheme to which an ACS technology and an ACM technology are applied may be determined as the rain attenuation compensation scheme.

The received channel state information may be used. When the HPA margin information included in the channel state information is analyzed and when an HPA margin of a terminal satisfies a predetermined criterion, the transmission power change scheme may be applied first to compensate for the rain attenuation.

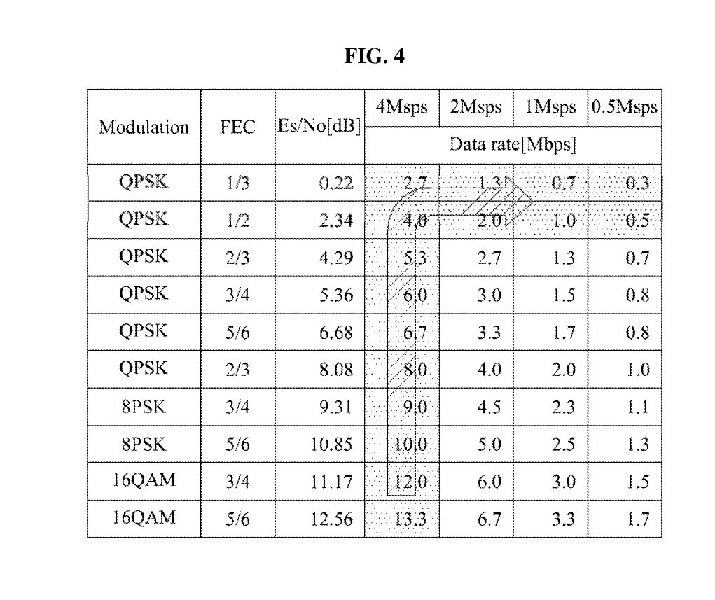

When the HPA margin is equal to or less than the predetermined criterion, the transmission speed change scheme or the MODCOD change scheme may be applied. Which one of the above two schemes is first applied will be described with reference to FIG. 4.

FIG. 4 is a diagram illustrating an order of a change in rain attenuation compensation schemes according to an embodiment.

When a transmission power change scheme is not applicable, because an HPA margin of a terminal is equal to or less than a predetermined criterion, a rain attenuation compensation scheme may change.

For example, when a transmission speed changes, an SNR of 3 dB increases. When a MODCOD that is operating in real time corresponds to Quadrature phase-shift keying (QPSK) at 4 Msps and a forward error correction (FEC) of 5/6, a maximum data rate may be 6.7 megabits per second (Mbps). In the present disclosure, the terms “transmission speed,” “symbol rate” and “data rate” may be used interchangeably with respect to each other.

When an additional HPA margin does not exist, the MODCOD may need to be additionally changed at 4 Msps, or the transmission speed may need to be changed.

For example, when a data rate is reduced to 2 Msps, an SNR may increase to 9.68 dB. However, in this example, a MODCOD for transmission at the SNR of 9.68 dB may correspond to an 8PSK and an FEC of 3/4, data may be transmitted at a data rate of 4.5 Mbps.

Accordingly, in FIG. 4, it is found that changing the MODCOD first at the same transmission speed is advantageous in terms of a throughput in comparison to changing the transmission speed first.

Referring back to operation 340 of FIG. 3, when the HPA margin is equal to or less than the predetermined criterion, the MODCOD change scheme may be applied at the same transmission speed, and a MODCOD may be reduced.

For example, when rain attenuation occurs even though the MODCOD change scheme is applied, a MODCOD margin of a terminal may be analyzed. When the MODCOD margin does not satisfy a predetermined criterion, a transmission speed change scheme may be determined as a rain attenuation compensation scheme.

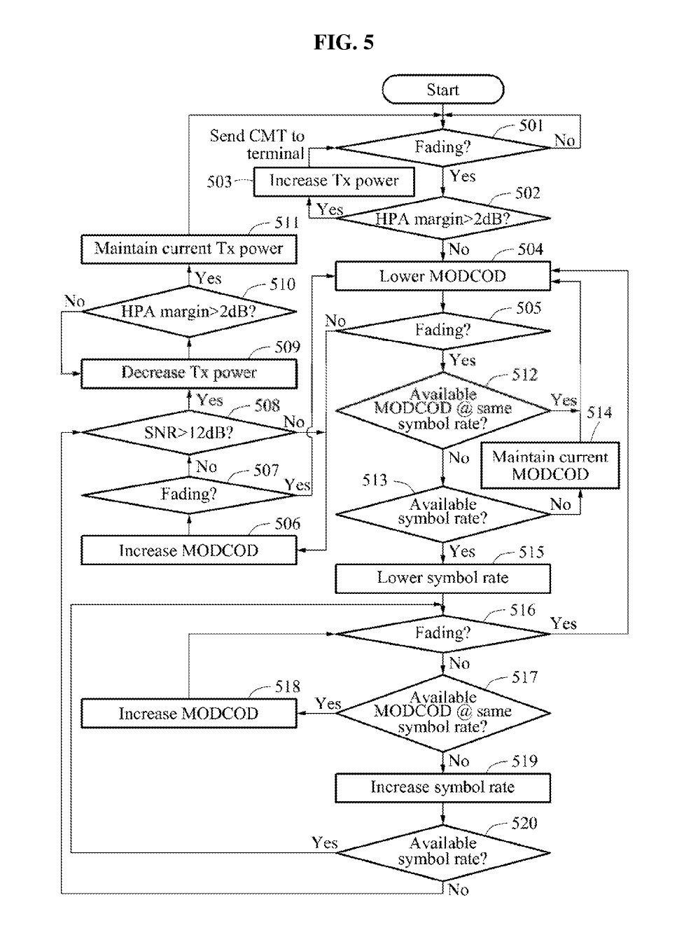

FIG. 5 is a flowchart illustrating an example of a method of compensating for return link rain attenuation according to an embodiment. The method of FIG. 5 may be provided to further describe a method of applying a rain attenuation compensation scheme, and may be performed by a return link rain attenuation compensation system.

In operation 501, whether rain attenuation occurs may be determined An occurrence of rain attenuation may be determined based on an SNR estimated based on channel state information received from a terminal. For example, an SNR may be compared to a predetermined criterion and an occurrence of rain attenuation may be determined

When the rain attenuation is determined to occur, whether an HPA margin exceeds a predetermined criterion may be determined in operation 502. For example, whether the HPA margin exceeds 2 dB may be determined, and information about an HPA margin of the terminal included in the received channel state information may be analyzed. When the HPA margin is determined to exist, a rain attenuation compensation scheme may be determined to increase a transmission power of the terminal in operation 503. In operation 501, whether the rain attenuation occurs may continue to be determined.

When the HPA margin does not exceed the predetermined criterion in operation 502, a MODCOD may be lowered in operation 504.

When the MODCOD is lowered, whether rain attenuation occurs may be determined in operation 505. For example, when the rain attenuation does not occur, the MODCOD may be increased again in operation 506, and whether rain attenuation occurs may be determined by increasing the MODCOD in operation 507. Accordingly, a maximum MODCOD at which rain attenuation does not occur may be set.

When the rain attenuation is determined not to occur in operation 507, whether the SNR exceeds a predetermined criterion may be determined in operation 508. For example, whether the SNR exceeds 12 dB may be determined When the SNR does not exceed the predetermined criterion, the MODCOD may be additionally increased in operation 506. When the SNR is determined to exceed the predetermined criterion in operation 508, the transmission power of the terminal may be reduced in operation 509.

When the transmission power is reduced, whether the HPA margin exceeds the predetermined criterion may be determined in operation 510. When the HPA margin is equal to or less than the predetermined criterion, the transmission power may be additionally reduced in operation 509. When the HPA margin exceeds the predetermined criterion, the transmission power of the terminal may be maintained without a change in operation 511.

When the rain attenuation is determined to occur even though the MODCOD is lowered in operation 505, whether a MODCOD margin available at the same transmission speed exists may be determined in operation 512.

When the MODCOD margin is determined to exist, a MODCOD change scheme to lower the MODCOD may be additionally performed in operation 504. Also, whether rain attenuation occurs may continue to be determined

When the MODCOD margin is determined not to exist in operation 512, whether a change in the transmission speed is possible may be determined in operation 513. When the change in the transmission speed is impossible, a current MODCOD may be maintained in operation 514 and whether fading occurs may be determined. When the change in the transmission speed is possible, a rain attenuation compensation scheme may be determined to lower the transmission speed in operation 515.

In operation 516, whether rain attenuation occurs even after the transmission speed is lowered may be determined. When the rain attenuation is determined to occur, a rain attenuation compensation scheme may be determined to lower the MODCOD in operation 504.

When the rain attenuation is determined not to occur in operation 516, whether a change in the MODCOD at the same transmission speed is possible may be determined in operation 517. When the change in the MODCOD is possible, the MODCOD may be increased in operation 518, a rain attenuation compensation scheme may be determined to maintain an optimum transmission environment that prevents an occurrence of rain attenuation.

When the change in the MODCOD is impossible in operation 517, the terminal may increase the transmission speed in operation 519. In operation 520, whether an additional change in the transmission speed is possible may be determined When the additional change in the transmission speed is possible, whether the rain attenuation occurs may be determined in operation 516. When the additional change in the transmission speed is impossible, the SNR may be compared to the predetermined criterion in operation 508, to change the transmission power and/or the MODCOD.

The above-described scheme may be applied as a rain attenuation compensation scheme. When rain attenuation occurs, a procedure of increasing a transmission output of a terminal, changing a MODCOD at the same transmission speed, and changing a transmission speed may be performed.

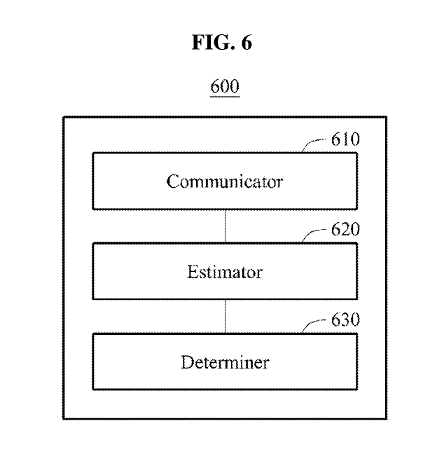

FIG. 6 is a block diagram illustrating a configuration of a return link rain attenuation compensation system to perform a return link rain attenuation compensation method according to an embodiment.

Referring to FIG. 6, the return link rain attenuation compensation system 600 includes a communicator 610, an estimator 620 and a determiner 630.

The communicator 610 may periodically receive channel state information from a terminal.

For example, channel state information may be received from each of all terminals connected via a satellite communication. The received channel state information may include at least one of HPA margin information of a terminal and data information of a terminal.

The estimator 620 may estimate an SNR based on the channel state information, and may determine whether rain attenuation is to be compensated for based on the estimated SNR.

For example, whether rain attenuation or fading occurs in a channel may be determined based on the estimated SNR. When a value of the estimated SNR is equal to or less than a predetermined reference value, the rain attenuation may be determined to occur. When the rain attenuation is determined to occur, the rain attenuation may be determined to be compensated for.

The determiner 630 may analyze the received channel state information and may determine a rain attenuation compensation scheme.

For example, at least one of a transmission power change scheme, a MODCOD change scheme and a transmission speed change scheme may be determined as the rain attenuation compensation scheme.

The received channel state information may be used. When the HPA margin information included in the channel state information is analyzed and when an HPA margin of a terminal satisfies a predetermined criterion, the transmission power change scheme may be applied first to compensate for the rain attenuation.

When the HPA margin is equal to or less than the predetermined criterion, the transmission speed change scheme or the MODCOD change scheme may be applied. For example, when the HPA margin is equal to or less than the predetermined criterion, the MODCOD change scheme may be applied at the same transmission speed, and a MODCOD may be lowered.

When the rain attenuation occurs even after the MODCOD change scheme is applied, a MODCOD margin of the terminal may be analyzed. When the MODCOD margin does not satisfy a predetermined criterion, the transmission speed change scheme may be determined as the rain attenuation compensation scheme.

The communicator 610 may transmit an operating mode change command corresponding to the determined rain attenuation compensation scheme to the terminal. In response to the received operating mode change command, the terminal may perform a communication by applying the rain attenuation compensation scheme.

According to embodiments, it is possible to overcome rain attenuation occurring in a return link based on a channel environment in a satellite communication system with great rain attenuation, by enhancing a throughput and availability of a system by changing a transmission speed and a transmission scheme.

The method according to the above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of compensating for return link rain attenuation in a satellite communication system, the method comprising:
periodically receiving channel state information from a terminal;
estimating a signal-to-noise ratio (SNR) based on the channel state information;
determining, based on the estimated SNR, whether rain attenuation is to be compensated for;
analyzing the channel state information and determining a rain attenuation compensation scheme; and
transmitting an operating mode change command corresponding to the rain attenuation compensation scheme to the terminal.

2. The method of claim 1, wherein the rain attenuation compensation scheme comprises at least one of a transmission power change scheme, a transmission speed change scheme, and a modulation and code rate (MODCOD) change scheme.

3. The method of claim 2, wherein the channel state information comprises at least one of high power amplifier (HPA) margin information of the terminal and data information of the terminal.

4. The method of claim 3, wherein the analyzing of the channel state information and determining of the rain attenuation compensation scheme comprises analyzing the HPA margin information, and when an HPA margin of the terminal satisfies a predetermined criterion, determining the transmission power change scheme as the rain attenuation compensation scheme.

5. The method of claim 4, wherein the analyzing of the channel state information and determining of the rain attenuation compensation scheme comprises analyzing the HPA margin information, and when the HPA margin of the terminal does not satisfy the predetermined criterion, determining the MODCOD change scheme as the rain attenuation compensation scheme.

6. The method of claim 5, wherein the analyzing of the channel state information and determining of the rain attenuation compensation scheme comprises analyzing a MODCOD margin of the terminal, and when the MODCOD margin does not satisfy the predetermined criterion, determining the transmission speed change scheme as the rain attenuation compensation scheme.

7. A system for compensating for return link rain attenuation to perform a method of compensating for return link rain attenuation, the system comprising:
a communicator configured to periodically receive channel state information from a terminal, and to transmit an operating mode change command corresponding to a rain attenuation compensation scheme to the terminal;
an estimator configured to estimate a signal-to-noise ratio (SNR) based on the channel state information, and to determine, based on the estimated SNR, whether rain attenuation is to be compensated for; and
a determiner configured to analyze the channel state information, and to determine a rain attenuation compensation scheme.

8. The system of claim 7, wherein the rain attenuation compensation scheme comprises at least one of a transmission power change scheme, a transmission speed change scheme, and a modulation and code rate (MODCOD) change scheme.

9. The system of claim 8, wherein the channel state information comprises at least one of high power amplifier (HPA) margin information of the terminal and data information of the terminal.
